(19) United States
(12) Patent Application Publication
(10) Pub. No.: US 2026/0174201 A1
(43) Pub. Date: Jun. 25, 2026

(54) CLIP-ON UMBRELLA

(71) Applicant: Shaoxing Unique Umbrella Co., Ltd, Shaoxing (CN)

(72) Inventor: Lijun Pan, Shangyu (CN)

(21) Appl. No.: 19/540,626

(22) Filed: Feb. 14, 2026

(30) Foreign Application Priority Data
Aug. 29, 2025 (CN) 202521860915.X
Dec. 20, 2025 (CN) 202522703934.8

(51) Int. Cl. A45B 19/00; A45B 19/04; A45B 19/10; A45B 23/00; A45B 25/14; B60N 2/07; F16B 2/10

(52) U.S. Cl. CPC A45B 19/00; A45B 11/00; A45B 19/04; A45B 19/10; F16B 2/10; A45B 2023/0037

(57) ABSTRACT

A clip-on umbrella is provided, including a bidirectional adjustment assembly and an umbrella shaft assembly. The bidirectional adjustment assembly includes a first adjustment seat, a second adjustment seat, a button, a hand lever, a hand wheel, and a fixed seat. Holes are formed in the first adjustment seat and the second adjustment seat, and a first vertical rod and a second vertical rod of the umbrella shaft assembly pass through the holes and are fixed. A placement slot that fits with the button and fixes the button is formed in a side wall of the first adjustment seat. The button internally has a cavity for facilitating the passing of the first vertical rod, and the button and the first vertical rod elastically press against each other to achieve fixed fit, thus facilitating fixing and movable lifting of the first vertical rod.

### TECHNICAL FIELD

The present disclosure relates to a daily necessity, and specifically relates to a clip-on umbrella. This application claims the priority of the preceding application No. 202521860915X, entitled with CLIP-ON UMBRELLA and filed on Aug. 29, 2025, and the preceding application NO. 2025227039348, filed on Dec. 20, 2025.

### BACKGROUND

A clip-on umbrella is a sunshade tool. There are a variety of styles of clip-on umbrellas. In one style, the entire clip-on umbrella is an L-shaped structure that is inverted at 90 degrees. In this way, a supporting rod tilts to one side to create a space under the umbrella for a user. The structure of the current clip-on umbrella can be adjusted by an adjustment function of an adjustment structure of a supporting rod. For example, the supporting rod only has a unidirectional longitudinal or transverse adjustment function, so that linkage cannot be achieved, and the function is single.

### SUMMARY

The present disclosure aims to provide a clip-on umbrella. A technical problem solved is to provide an umbrella in which it is convenient to perform longitudinal lifting and transverse rotation on a supporting rod of the umbrella.

A clip-on umbrella includes a bidirectional adjustment assembly and an umbrella shaft assembly. The bidirectional adjustment assembly includes a first adjustment seat, a button, a hand lever, a hand wheel, and a fixed seat. A hole is formed in the first adjustment seat, and a first vertical rod and a second vertical rod of the umbrella shaft assembly pass through the hole and are fixed. A placement slot that fits with the button and fixes the button is formed in a side wall of the first adjustment seat. The button internally has a cavity for facilitating the passing of the first vertical rod. The button and the first vertical rod elastically press against and fixedly fit with each other, thus facilitating fixing and movable lifting of the first vertical rod. The hand lever is sleeved into the second vertical rod and is screwed with the hand wheel and fixed with the second vertical rod. The hand wheel resists against the first adjustment seat to control mutual engagement or disengagement between the first adjustment seat and the fixed seat.

A first protrusion and a second protrusion are provided on a side wall of the button, and the two protrusions are oppositely disposed on two sides of the side wall. The first protrusion fits with a fixing hole of the first vertical rod. The second protrusion fits with a spring at a corresponding position of the first adjustment seat.

The clip-on umbrella further includes a second adjustment seat. A hole is formed in the second adjustment seat, and the first vertical rod and the second vertical rod of the umbrella shaft assembly pass through the hole and are fixed.

One through hole is formed in each of a left side and a right side of each of the first adjustment seat and the second adjustment seat. The through holes in one sides fit with the first vertical rod, and the through holes in the other sides fit with the second vertical rod. The first vertical rod and the second vertical rod are parallel to each other and are spaced apart from each other.

A pin hole is formed in a bottom of the hand wheel. Pin holes are also formed in corresponding positions of the fixed seat and the second vertical rod. One fixing pin fits with the pin holes to achieve mutual fixation of the hand lever, the fixed seat, and the second vertical rod.

The hand lever has a thread. The hand wheel also has a thread at a corresponding position. The hand wheel presses against the first adjustment seat through the threads to control the mutual engagement or disengagement between the first adjustment seat and the fixed seat. A bottom of the first vertical rod is fixedly assembled with the second adjustment seat.

The clip-on umbrella further has a rotary adjustment assembly. The rotary adjustment assembly has a pressing member, a fixed grip, a rotary grip, a rotation stop tooth, and a reset spring. The fixed grip and the rotary grip wrap around the rotation stop tooth and the reset spring. One portion of the pressing member partially extends into the fixed grip and is in pressing fit with the rotation stop tooth. The fixed grip, the rotary grip, and the rotation stop tooth have tooth slots in fit positions. The rotation stop tooth fits with the tooth slots and the reset spring to implement mutual fixation or relative rotation between the fixed grip and the rotary grip. An end portion of one end of the rotary grip is assembled with an umbrella rib of the clip-on umbrella. The umbrella rib is configured on an upper plate of the clip-on umbrella, abuts against an umbrella surface, and slantways deviates from a central line of the umbrella surface of the clip-on umbrella. The fixed grip is assembled with one end of the second vertical rod.

The pressing member has symmetric notches to form two spaced side walls, and a flange that extends outwards to form a skirt structure is formed on the side walls. The fixed grip has a half slot at a corresponding position that fits with the side walls. The fixed grip has a stop slot at a corresponding position that fits with the flange.

The fixed grip and the rotary grip have holes, and a screw fits with the holes to implement fixation between the fixed grip and the rotary grip.

The clip-on umbrella further includes a fixed adjustment assembly. The fixed adjustment assembly includes a clip head, a clip handle, a first clip cap, a first screw rod, a second clip cap, and a second screw rod. One end of the clip head is designed with a clamping end with a clip structure, and the other opposite end has an engagement end. The engagement end has an engagement tooth. The clip handle is assembled at a bottom of the second vertical rod, and also has an engagement tooth towards the engagement tooth of the clip head. The engagement tooth of the clip head and the engagement tooth of the clip handle are mutually movably engaged to implement rotation of the clip handle. The fixed adjustment assembly further includes a first clip cap, a first screw rod, a second clip cap, and a second screw rod. The first clip cap and the first screw rod fit with each other to implement the mutual movable engagement between the engagement tooth of the clip head and the engagement tooth of the clip handle. The second clip cap and the second screw rod fit with each other to implement clamping and releasing of the clamping end.

Beneficial effects of the present disclosure are as follows: By designing the bidirectional adjustment assembly, it is convenient for the longitudinal lifting of the first vertical rod and also convenient for the transverse rotation of the first vertical rod. By designing the rotary adjustment assembly, it is convenient to rotate the umbrella rib around the rotary adjustment assembly serving as a center. By designing the fixed adjustment assembly, it is convenient to rotate other components of the clip-on umbrella around the fixed adjustment assembly serving as a center.

### BRIEF DESCRIPTION OF THE DRAWINGS

FIG. 1 is a schematic diagram of a clip-on umbrella;

FIG. 2 is a schematic diagram of fit of a rotary adjustment assembly, a bidirectional adjustment assembly, a fixed adjustment assembly, and an umbrella shaft assembly of a clip-on umbrella; FIG. 3 is an exploded view of the clip-on umbrella of FIG. 2;

FIG. 4 is a schematic diagram of the clip-on umbrella of FIG. 2, viewed in another angle;

FIG. 5 is an exploded view of the clip-on umbrella of FIG. 4;

FIG. 6 is a schematic diagram of a clip-on umbrella being folded;

FIG. 7 is a schematic diagram of the clip-on umbrella of FIG. 1, from which a second adjustment seat is removed;

FIG. 8 is a schematic diagram of a usage scenario in which the clip-on umbrella of FIG. 7 is fixed on a stool;

FIG. 9 is a schematic diagram of use of a locking assembly on a clip-on umbrella, in which the circle represents an enlarged view of the locking assembly;

FIG. 10 is a schematic diagram of a locking assembly;

FIG. 11 is a schematic diagram of a fixed plate buckle in a locking assembly;

FIG. 12 is a schematic diagram of a movable plate buckle in a locking assembly; and

FIG. 13 is a schematic diagram of a pressing block in a locking assembly.

### IN THE DRAWINGS

1: bidirectional adjustment assembly; 11: first adjustment seat; 111: placement slot; 12; second adjustment seat; 13: button; 131: first protrusion; 132: second protrusion; 14: hand lever; 15: hand wheel; 16: fixed seat; 17: through hole; 18: engagement tooth; 19: thread; 110: fixing pin; 111: pin hole;
2: umbrella shaft assembly; 21: first vertical rod; 22: second vertical rod; 23: fixing hole;
3: rotary adjustment assembly; 31: pressing member; 311: notch; 312: flange; 32: fixed grip; 321: half slot; 322: stop slot; 33: rotary grip; 34: rotation stop tooth; 35: reset spring; 36: tooth slot;
41: umbrella rib; 42: umbrella grip; 43: upper plate; 44: lower plate; 45: pull tab;
5: fixed adjustment assembly; 51: clip head; 511: clamping end; 512: engagement end; 52: clip handle; 53: first clip cap; 54: first screw rod; 55: second clip cap; 56: second screw rod;
6: locking assembly;
61: fixed buckle plate; 611: first fixing hole; 612: second fixing hole; 613: shaft connection end; 614: placement cavity;
62: movable plate buckle; 621: eccentric wheel; 6211; irregular contour; 622: wrench portion;
63: pressing block; 631: arc portion; 6311: arc surface; and 632: fixed portion.

### DETAILED DESCRIPTION OF THE EMBODIMENTS

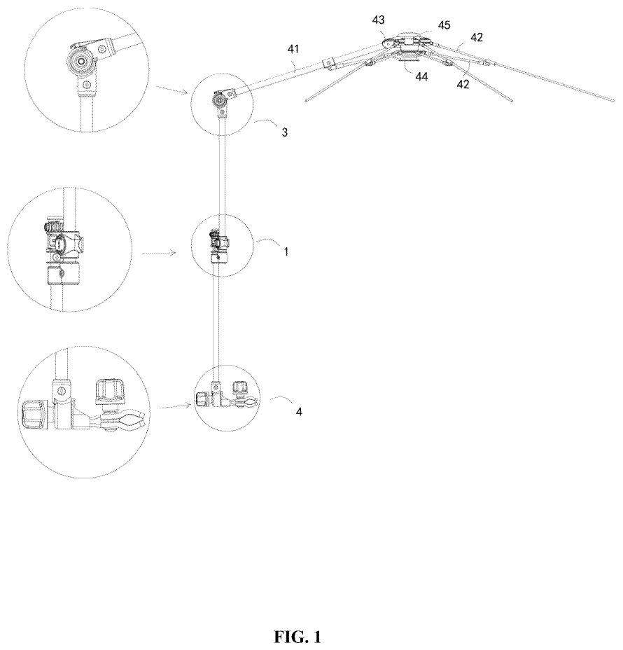

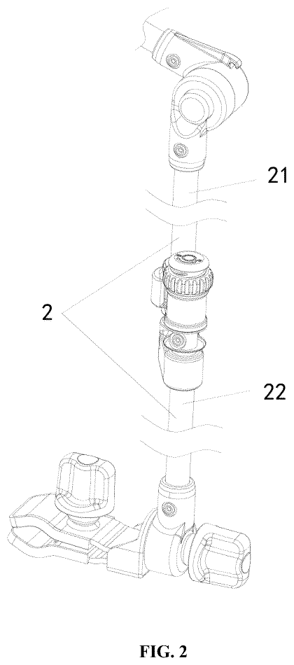

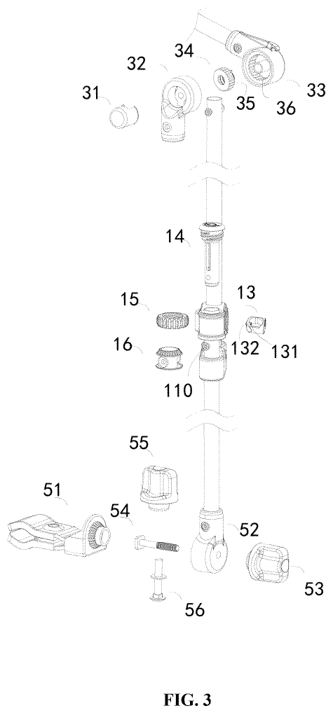

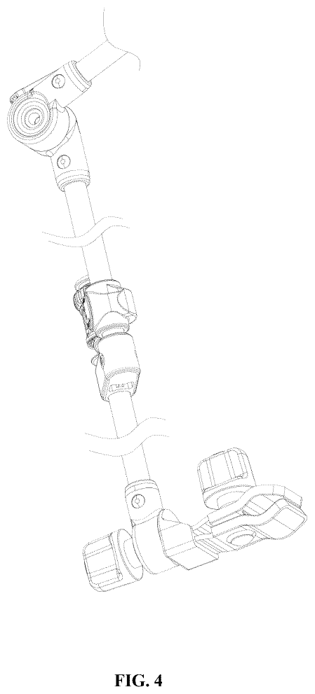

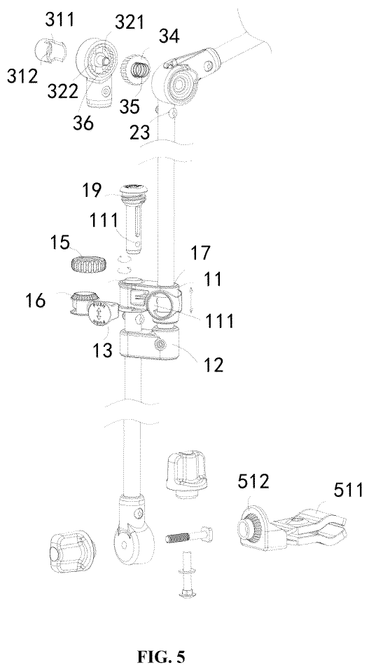

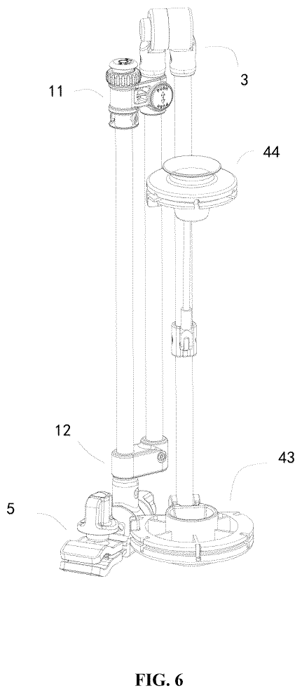

Referring to FIG. 1 to FIG. 6, a clip-on umbrella is primarily designed with components such as an umbrella shaft assembly 2, a bidirectional adjustment assembly 1, a rotary adjustment assembly 3, and a fixed adjustment assembly 5. The umbrella shaft assembly 2 is configured for connection, supporting, and fixation with other assemblies. The bidirectional adjustment assembly 1 is configured to implement bidirectional adjustment on an umbrella shaft with respect to longitudinal lifting and transverse rotation. The rotary adjustment assembly 3 is configured to rotate an umbrella rib 41, an upper plate 43, a lower plate 44, an umbrella surface, and other components. The fixed adjustment assembly 5 is configured to fix the entire clip-on umbrella onto a platform such as a deck chair and can perform a rotation action. In practical applications, the above components can be further optimized in design, such as by improving design elements such as the shape, the construction, the quantity, and the material, or by replacing the components with components having the same functions, or by additionally adding other components.

The umbrella shaft assembly 2 in the figure is primarily designed with two components: a first umbrella shaft and the second umbrella shaft. Each umbrella shaft uses a hollow cylindrical design of an existing umbrella shaft, an end portion or a position close to the end portion of each umbrella shaft is perforated to facilitate subsequent fixation with other components through conventional fixing members such as a screw, thus fixing, or supporting, or achieving a corresponding effect on other components.

The bidirectional adjustment assembly 1 in the figure is primarily designed with a first adjustment seat 11, a second adjustment seat 12, a button 13, a hand lever 14, a hand wheel 15, a fixed base 16, and other components.

Through holes 17 are designed on two sides of the first adjustment seat 11. This facilitates passing and fixation of a top position of the second vertical rod 22 and a bottom position of the first vertical rod 21. A placement slot 111 is designed on one side of the first adjustment seat 11. This facilitates placement and fixation of the button 13. A structure of a conical engagement tooth 18 is designed at a position of the first adjustment seat 11 that fits with the fixed seat 16. This facilitates subsequent engagement or disengagement of an engagement tooth 18 on the fixed seat 16. Through holes 17 are also designed on two sides of the second adjustment seat 12. This facilitates passing and fixation of the first vertical rod 21 and the second vertical rod 22. A bottom of the first vertical rod 21 is fixed to one side of the second adjustment seat 12 through a conventional fixing member, and the other side of the second adjustment seat 12 remains being movably assembled with the second vertical rod 22. In this way, the second adjustment seat 12 can perform a lifting action on the first vertical rod 21, thereby achieving a storage or unfolding function. That is, when the fixing member between the first vertical rod 21 and the second adjustment seat 12 is released, the second adjustment seat 12 can slide downwards on the second vertical rod 22, thus lowering the first vertical rod 21 to facilitate storage. Similarly, it is also convenient to the upward movement of the first vertical rod 21, thereby facilitating the opening of an umbrella. With the above configuration, the first vertical rod 21 and the second vertical rod 22 are spaced apart from each other in parallel. This facilitates subsequent adjustment on longitudinal lifting and transverse rotation.

The button 13 can use a part of an existing sunshade product such as an umbrella or a tent, and its specific structure is as shown in the figures. The button 13 is integrally formed by a circular side wall and a U-shaped side wall, and is internally hollowed out to facilitate the passing of the first vertical rod 21. Structures of a first protrusion 131 and a second protrusion 132 are designed in two opposite directions of the U-shaped side wall. The first protrusion 131 can fit with the hole, i.e., the fixing hole 23, of the first vertical rod 21 to lock the first vertical rod 21, and the second protrusion 132 is in contact with an inner wall of the first adjustment seat 11 in conjunction with a spring, thus forming an elastic fit relationship to facilitate locking on the first vertical rod 21 and resetting of the button 13.

The entire hand lever 14 is a rod-shaped structure. A top of the hand lever is similar to a circular cap that presses the hand wheel 15. A structure of a thread 19 is disposed below the circular cap. This facilitates threaded fit with a thread 19 of the hand wheel 15, and thus, it is convenient for the hand wheel 15 to longitudinally move upwards and downwards on the hand lever 14. A locking hole structure is provided in a bottom of the hand lever 14, and the fixed seat 16 and the second vertical rod 22 also have pin holes 111 in corresponding positions. By configuring a pin, the fixed seat 16, the second vertical rod 22, and the hand lever 14 can be fixed together, to ensure that the fixed seat 16 and the hand lever 14 are not rotated.

The entire hand wheel 15 is hollow cylindrical structure, which is similar to a small elastic ring style. A middle-lower portion of the hand wheel 15 is sleeved into the second vertical rod 22. The thread 19 is used to implement the upward and downward movement of the hand lever 14. In this way, a force relationship that presses against the first adjustment seat 11 is formed, so that the engagement tooth 18 of the first adjustment seat 11 and the engagement tooth 18 of the fixed seat 16 can remain in an engaged relationship or a disengaged relationship. That is, when the hand wheel 15 moves downwards relative to the hand lever 14, the hand wheel 15 presses the first adjustment seat 11, so that the engagement tooth 18 of the first adjustment seat 11 and the engagement tooth 18 of the fixed seat 16 are engaged to form a locked state. Since the fixed seat 16 is fixed by the pin, the fixed seat 16 cannot be rotated, and the first adjustment seat 11 cannot be transversely rotated either. When the hand wheel 15 moves upwards relative to the hand lever 14, the hand wheel 15 releases the first adjustment seat 11, so that the engagement tooth 18 of the first adjustment seat 11 can be disengaged from the engagement tooth 18 of the fixed seat 16 to form a non-locked state. In this way, the first adjustment seat 11 is transversely rotated to drive the first vertical rod 21 to transversely rotate.

The rotary adjustment assembly 3 in the figure is primarily designed with a pressing member 31, a fixed grip 32, a rotary grip 33, a rotation stop tooth 34, and a reset spring 35. The pressing member 31 is designed with symmetric notches 311 to form two spaced side walls, and a flange 312 that extends outwards to form a skirt structure is formed on the side walls. In order to fit with the pressing member 31, the fixed grip 32 has a half slot 321 at a corresponding position that fits with the side walls, to facilitate passing through the side walls of the pressing member 31. The fixed grip 32 has a stop slot 322 in a corresponding position that fits with the flange 312, thus sleeving and fixing the pressing member 31. The first vertical rod 21 is mounted at a bottom of the fixed grip 32. The umbrella rib 41 is mounted on the rotary grip 33. The fixed grip 32 and the rotary grip 33 internally have cavity structures for placing the rotation stop tooth 34 and the reset spring 35. Meanwhile, the two grips also internally have structures of tooth slots 36 to form an engagement relationship with the rotation stop tooth 34. When the pressing member 31 is not pressed, the rotation stop tooth 34 are engaged with the tooth slots 36 of the two rotary grips respectively. In this way, since the fixed grip 32 is fixed to the first vertical rod 21, the rotary grip 33 can be locked through the rotation stop tooth 34. When the rotary grip 33 needs to be rotated, the pressing member 31 is pressed, and the pressing member 31 can press the rotation stop tooth 34 towards the rotary grip 33, so as to be separated from the fixed grip 32. In this way, the two rotary grips form a disengagement relationship to achieve relative rotation. When the rotary grip is adjusted to a set angle, the pressing member 31 is released.

Under the action of the reset spring 35, the stop tooth returns to its original position and the pressing member is reset, so that the two rotary grips are locked and mutually fixed. To fix the fixed grip 32 and the rotary grip 33, holes for mounting can be designed in the fixed grip 32 and the rotary grip 33 based on an existing manner, and a screw fits with the holes to fix the fixed grip 32 and the rotary grip 33.

The umbrella rib 41 is a conventional component on the clip-on umbrella. One end of the umbrella rib 41 is mounted on the rotary grip 33 and the other end is mounted on the upper plate 43. Meanwhile, the upper plate 43 is designed with a pull tab 45. It facilitates expansion of an umbrella surface of the clip-on umbrella.

The fixed adjustment assembly 5 in the figure simulates the rotary adjustment assembly 3 on a rotary locking structure, which adopts the mutual engagement or disengagement of the engagement teeth 18. As shown in the figure, the fixed adjustment assembly 5 is designed with a clip head 51, a clip handle 52, a first clip cap 53, a first screw rod 54, a second clip cap 55, and a second screw rod 56. The above clip head 51 is designed with a clamping end 511 with a clip structure at one end,

making it convenient to fix the entire fixed adjustment assembly 5 on a platform, and the other end of the clip head 51 is designed with an engagement end 512 with an engagement tooth 18. The entire clip handle 52 is mounted at a bottom of the second vertical rod 22, thereby supporting the second vertical rod 22 and other components. The clip handle 52 is also designed with an engagement tooth 18 towards the engagement tooth 18 of the clip head 51. By designing the two engagement teeth 18, the clip head 51 and the clip handle 52 can be movably engaged or fixed. To ensure the mutual movable engagement between the clip head 51 and the clip handle 52, the first clip cap 53 and the first screw rod 54 are designed and are assembled based on the existing manner. To clamp or release the clamping end 511, the second clip cap 55 and the second screw rod 56 that fit with each other are designed at the clamping end 511 and are assembled based on the existing manner.

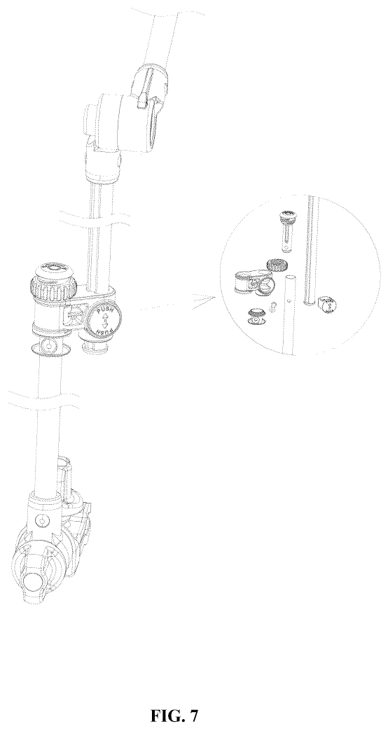

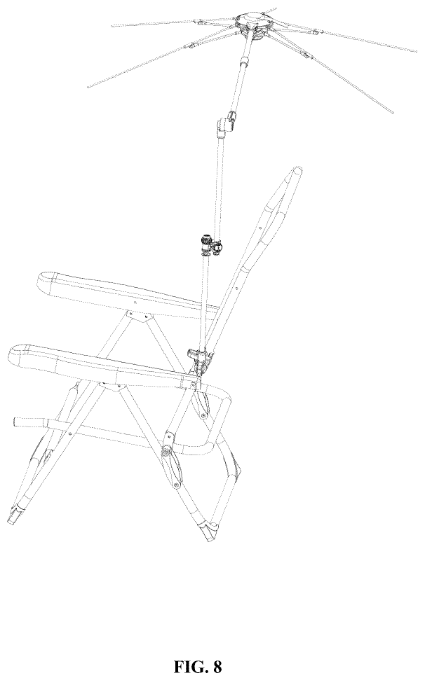

Referring to FIG. 7 to FIG. 8, the second adjustment seat 12 is removed from the clip-on umbrella in the figure. This simplifies the overall structure of the clip-on umbrella and reduces the costs of the clip-on umbrella.

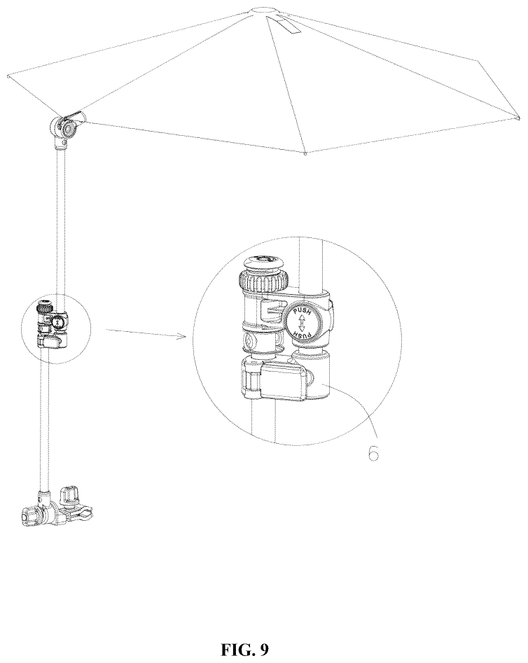

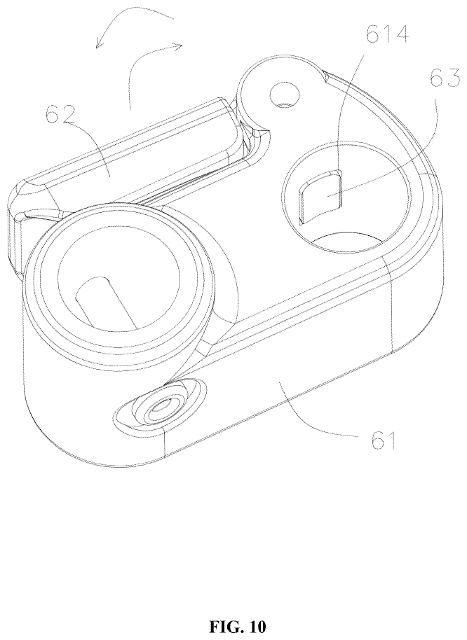

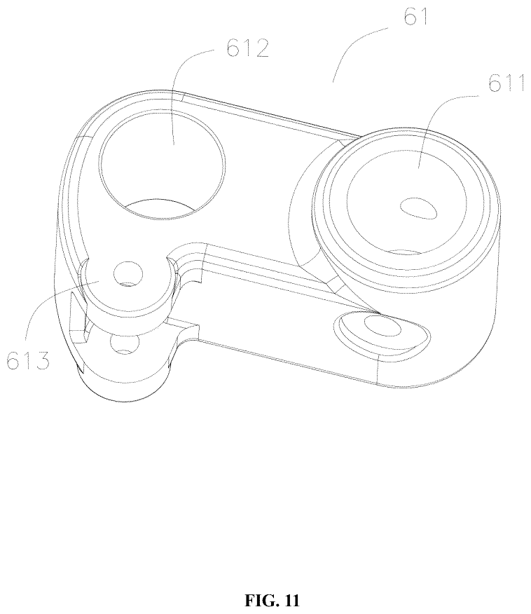

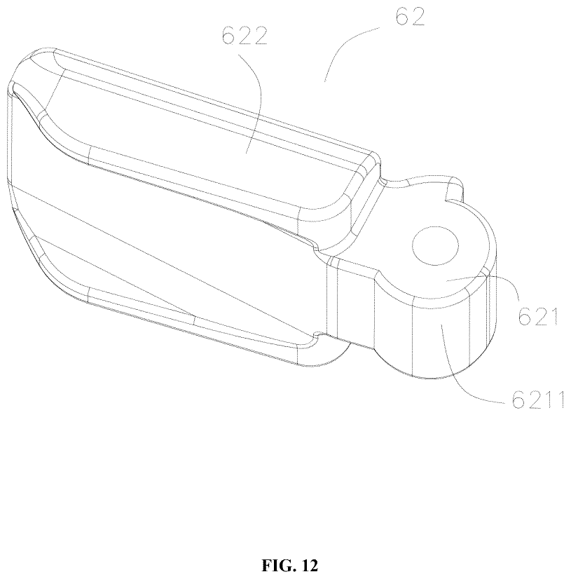

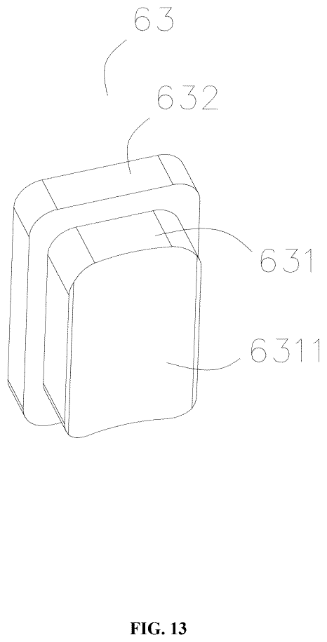

Referring to FIG. 9 to FIG. 13, the clip-on umbrella in the figure is also added with a locking assembly 6 to replace the original second adjustment seat 12, or the second adjustment seat 12 can be optimized from fixed compression to movable compression. The locking assembly 6 is configured to avoid shaking between the first vertical rod 21 and the second vertical rod 22, to form an integral structure, so that upper and lower components are all fixedly wrapped around. The locking assembly 6 in the figure is designed with a fixed plate buckle 61, a movable plate buckle 62, and a pressing block 63. The fixed plate buckle 61 is configured to simultaneously sleeve the first vertical rod 21 and the second vertical rod 22. The movable plate buckle 62 is configured to movably compress the second vertical rod 22 through the pressing block 63. The pressing block 63 is configured to compress the second vertical rod 22. As shown in the figure, the fixed plate buckle 61 is designed with a first fixing hole 611 and a second fixing hole 612 in left and right positions respectively. The first fixing hole 611 sleeves the first vertical rod 21, and the second fixing hole 612 sleeves the second vertical rod 22. Meanwhile, a shaft connection end 613 that facilitates easy shaft connection, i.e. hinge, with the movable plate buckle 62 is designed in a position close to the second fixing hole 612. A placement cavity 614 that penetrates through the second fixing hole 612 and a cavity of the shaft connection end 613 is provided at an inner wall position of the second fixing hole 612. The placement cavity 614 is mainly configured to place the pressing block 63. The movable plate buckle 62 is designed with a structure of an eccentric cam 621 at the shaft connection end 613 of the fixed plate buckle 61. In this way, the irregular contour 6211 of the cam is used to drive the pressing block 63 to move in an axial center direction of the second fixing hole 612, thereby achieving a clamping effect on the second vertical rod 22. For ease of the above operation, a wrench portion 622 similar to a wrench structure can be designed to perform a plate tightening operation. The pressing block 63 in the figure is overall of a structure similar to an embedded block, which has a fixed portion 632 and an arc portion 631. A transverse area of the fixed portion 632 is larger than a transverse area of the arc portion 631. In this way, a shape of the pressing block corresponds to a shape of the placement cavity 614 of the fixed plate buckle 61, to facilitate the placement into the placement cavity 614. The arc portion 631 is designed with an arc surface 6311 to abut against an outer surface of the second vertical rod 22.

The specific embodiments described here are only intended to explain this technical solution and are not intended to limit this technical solution. In the description of this technical solution, it should be noted that orientations or positional relationships indicated by the terms “upper”, “inner”, and the like are orientations or positional relationships as shown in the drawings, and are only for the purpose of facilitating and simplifying the description of this technical solution instead of indicating or implying that devices or elements indicated must have particular orientations, and be constructed and operated in the particular orientations, so that these terms are not construed as limiting this technical solution.

Meanwhile, in the description of this technical solution, it should be noted that unless otherwise explicitly specified or limited, the terms “fix” and “fit” shall be construed broadly and may be, for example, fixed connection, detachable connection, integrated connection, direct connection, indirect connection via an intermediate, internal communication between two elements, or interaction relationship between two elements. A person of ordinary skill in the art may understand the specific meanings of the foregoing terms in this technical solution according to specific situations.

Although the embodiments of this technical solution have been shown and described, it can be understood by those of ordinary skill in the art that various changes, modifications, substitutions, and variations can be made to these embodiments without departing from the principle and spirit of this technical solution. The scope of this technical solution is defined by the accompanying claims and their equivalents.

What is claimed is:

1. A clip-on umbrella, comprising a bidirectional adjustment assembly (1) and an umbrella shaft assembly (2), wherein the bidirectional adjustment assembly (1) comprises a first adjustment seat (11), a button (13), a hand lever (14), a hand wheel (15), and a fixed seat (16); a hole is formed in the first adjustment seat (11), and a first vertical rod (21) and a second vertical rod (22) of the umbrella shaft assembly (2) pass through the hole and are fixed; a placement slot (111) that fits with the button (13) and fixes the button (13) is formed in a side wall of the first adjustment seat (11); the button (13) internally has a cavity for facilitating the passing of the first vertical rod (21); the button (13) and the first vertical rod (21) elastically press against and fixedly fit with each other, thus facilitating fixing and movable lifting of the first vertical rod (21); the hand lever (14) is sleeved into the second vertical rod (22) and is screwed with the hand wheel (15) and fixed with the second vertical rod (22); and the hand wheel (15) resists against the first adjustment seat (11) to control mutual engagement or disengagement between the first adjustment seat (11) and the fixed seat (16).

2. The clip-on umbrella according to claim 1, wherein a first protrusion (131) and a second protrusion (132) are provided on a side wall of the button (13), and the two protrusions are oppositely disposed on two sides of the side wall; the first protrusion (131) fits with a fixing hole (23) of the first vertical rod (21); and the second protrusion (132) fits with a spring at a corresponding position of the first adjustment seat (11).

3. The clip-on umbrella according to claim 1, wherein the clip-on umbrella further comprises a second adjustment seat (12); and a hole is formed in the second adjustment seat (12), and the first vertical rod (21) and the second vertical rod (22) of the umbrella shaft assembly (2) pass through the hole and are fixed.

4. The clip-on umbrella according to claim 3, wherein one through hole (17) is formed in each of a left side and a right side of each of the first adjustment seat (11) and the second adjustment seat (12); the through holes (17) in one sides fit with the first vertical rod (21), and the through holes (17) in the other sides fit with the second vertical rod (22); and the first vertical rod (21) and the second vertical rod (22) are parallel to each other and are spaced apart from each other.

5. The clip-on umbrella according to claim 3, wherein a pin hole (111) is formed in a bottom of the hand wheel (14); pin holes (111) are also formed in corresponding positions of the fixed seat (16) and the second vertical rod (22); one fixing pin (110) fits with the pin holes (111) to achieve mutual fixation of the hand lever (14), the fixed seat (16), and the second vertical rod (22).

6. The clip-on umbrella according to claim 3, wherein the hand lever (14) has a thread (19); the hand wheel (15) also has a thread (19) at a corresponding position; the hand wheel (15) presses against the first adjustment seat (11) through the threads (19) to control the mutual engagement or disengagement between the first adjustment seat (11) and the fixed seat (16); and a bottom of the first vertical rod (21) is fixedly assembled with the second adjustment seat (12).

7. The clip-on umbrella according to claim 3, wherein the clip-on umbrella further has a rotary adjustment assembly (3); the rotary adjustment assembly (3) has a pressing member (31), a fixed grip (32), a rotary grip (33), a rotation stop tooth (34), and a reset spring (35); the fixed grip (32) and the rotary grip (33) wrap around the rotation stop tooth (34) and the reset spring (35); one portion of the pressing member (31) partially extends into the fixed grip (32) and is in pressing fit with the rotation stop tooth (34); the fixed grip (32), the rotary grip (33), and the rotation stop tooth (34) have tooth slots (36) in fit positions; the rotation stop tooth (34) fits with the tooth slots (36) and the reset spring (35) to implement mutual fixation or relative rotation between the fixed grip (32) and the rotary grip (33); an end portion of one end of the rotary grip (33) is assembled with an umbrella rib (41) of the clip-on umbrella; the umbrella rib (41) is configured on an upper plate (43) of the clip-on umbrella, abuts against an umbrella surface, and slantways deviates from a central line of the umbrella surface of the clip-on umbrella; and the fixed grip (32) is assembled with one end of the second vertical rod (22).

8. The clip-on umbrella according to claim 7, wherein the pressing member (31) has symmetric notches (311) to form two spaced side walls, and a flange (312) that extends outwards to form a skirt structure is formed on the side walls; the fixed grip (32) has a half slot (321) at a corresponding position that fits with the side walls; and the fixed grip (32) has a stop slot (322) at a corresponding position that fits with the flange (312).

9. The clip-on umbrella according to claim 8, wherein the fixed grip (32) and the rotary grip (33) have holes, and a screw fits with the holes to implement fixation between the fixed grip (32) and the rotary grip (33).

10. The clip-on umbrella according to claim 3, wherein the clip-on umbrella further comprises a fixed adjustment assembly (5); the fixed adjustment assembly (5) comprises a clip head (51), a clip handle (52), a first clip cap (53), a first screw rod (54), a second clip cap (55), and a second screw rod (56); one end of the clip head (51) is designed with a clamping end (511) with a clip structure, and the other opposite end has an engagement end (512); the engagement end (512) has an engagement tooth (18); the clip handle (52) is assembled at a bottom of the second vertical rod (22), and also has an engagement tooth (18) towards the engagement tooth (18) of the clip head (51); the engagement tooth (18) of the clip head (51) and the engagement tooth (18) of the clip handle (52) are mutually movably engaged to implement rotation of the clip handle (52); the fixed adjustment assembly (5) further comprises a first clip cap (53), a first screw rod (54), a second clip cap (55), and a second screw rod (56); the first clip cap (53) and the first screw rod (54) fit with each other to implement the mutual movable engagement between the engagement tooth (18) of the clip head (51) and the engagement tooth (18) of the clip handle (52); and the second clip cap (55) and the second screw rod (56) fit with each other to implement clamping and releasing of the clamping end (511).

11. The clip-on umbrella according to claim 1, wherein the clip-on umbrella further comprises a locking assembly (6); the locking assembly (6) is designed with a fixed plate buckle (61), a movable plate buckle (62), and a pressing block (63); the fixed plate buckle (61) has a first fixing hole (611) and a second fixing hole (612), to respectively sleeve and fix the first vertical rod (21) and the second vertical rod (22); the fixed plate buckle (61) further has a shaft connection end (613) for facilitating shaft connection with the movable plate buckle (62); at a position of the shaft connection end (613), an inner wall of the fixed plate buckle (61) is penetrated through to form a placement cavity (614); a pressing block (63) is placed inside the placement cavity (614); the movable plate buckle (62) is designed with an eccentric cam (621) and a wrench portion (622) at the position of the shaft connection end (613); the eccentric cam (621) has an irregular contour (6211) such that the pressing block (63) moves in an axial center direction of the second fixing hole (612) to fix the second vertical rod (22); the wrench portion (622) is fixed with the eccentric cam (621) to drive the eccentric cam (621) to rotate; the pressing block (63) has a fixed portion (632) and an arc portion (631); the fixed portion (632) is located inside the placement cavity (614) of the fixed plate buckle (61); and the arc portion (631) has an arc surface (6311), and movably abuts against and is fixed with the second vertical rod (22).
